(19) United States
(12) Patent Application Publication
(10) Pub. No.: US 2015/0327525 A1
(43) Pub. Date: Nov. 19, 2015

(54) Valley Hook

(71) Applicant: Charles J. Noack, JR., Franksville, WI (US)

(72) Inventor: Charles J. Noack, JR., Franksville, WI (US)

(21) Appl. No.: 14/711,392

(22) Filed: May 13, 2015

Related U.S. Application Data
(60) Provisional application No. 61/992,287, filed on May 13, 2014.

(51) Int. Cl. A01K 83/00; A01K 91/04

(52) U.S. Cl. CPC A01K 83/00; A01K 91/04

(57) ABSTRACT

A fish hook or line coupling device having a “valley crook” attachment feature for catching a knot of a fishing line and circumventing the hassle of stringing a fish line through the eye of a conventional fish hook and tying a fishing knot. The “valley crook” attachment includes a stem extending from the shaft of a fish hook or coupler to a bend providing a gap between the stem and a tail. The gap has a width less than a diameter of a knot in a fishing line. The tail may have an inward bend for catching the line within the gap, and the tail may be outwardly flared to facilitate installation of the line into the gap.

### CROSS-REFERENCE TO RELATED APPLICATIONS

This application claims the benefit of US Provisional Application 61/992,287 filed May 13, 2014 and hereby incorporated by reference.

### BACKGROUND OF THE INVENTION

The present invention relates to fish hooks and line coupling devices and in particular to a fish hook and line coupling device which provide an easy no tie attachment of a fish hook or line coupling device to a fishing line. Further, the present invention relates to a fish hook or line coupling device having a “valley crook” attachment feature for catching a knot and accepting of a fishing line through or around the eye of a conventional fish hook and securing it with the appropriate tied knot.

A typical fish hook has an eye, which is fully or substantially closed for receiving a fish line. Tying the line and fish hook together can be a tedious and burdensome process. It requires inserting the fishing line through a relatively small eye of the hook, then creating a knot, e.g., twisting the line a number of times around the shaft or line, and threading the line back through a small hole which was made by twisting the line, and pulling the line to tighten the coils to complete the knot. People who do not go fishing on a fairly regular basis must often refresh their memories or repeatedly receive instructions as to how to tie and knot the line properly to the fish hook. It can take several minutes for a novice fisherman to get his or her traditional fish hook tied to the line the properly.

Therefore, a no-tie fishing hook or line coupling device is desired which facilitates the attachment of a fish hook to a line without comprising the strength of the attachment.

### SUMMARY OF THE INVENTION

The present invention brings a unique and novel device and method for attaching a fish hook to a fishing line. It will benefit fishermen, women, and children of all age groups who enjoy fishing but do not want the hassle or complication of attaching a fishing line to a traditional or conventional fish hook. The present invention simplifies the process and makes it faster to accomplish. It is more user friendly than the traditional hook known in the art because of its novel “valley crook” feature.

The present invention is designed with a “valley crook” in which a simple knot of a fishing line passes through and slides into and catches therein. The line is then looped once over completing the attachment and giving it added strength and security. It only takes seconds to complete. The present invention provides simplicity, strength, and convenience to the user while at the same time allowing the user to continue using most any kind of fishing line including, e.g., a lead core line.

The present invention provides a fish hook having a point on a first end extending to a bend and a shank connecting the bend to a second end. An attachment “valley crook” is located at the second end having a stem extending from the shaft into a U-shaped bend defining a gap. A tail extends from the U-shaped bend running generally parallel to the shaft, and then bending away from the shaft to create a non-abrasive entry point for the fishing line. The gap between the stem and the tail has a width less than a diameter of a knot of a fishing line. After the line partially enters the “valley crook,” the stem widens to the width of the fishing line being used. The “valley crook” has various widths depending on which line the user is using. Therefore, as the “valley crook” is designed for adapting to various fishing line diameters, the general shape remains the same, while the bends in the shaft from the first end to the second end may be modified for different types of fishing techniques.

The attachment “valley crook” may be angled away from the first end to facilitate attachment of the line.

An inward bend in the tail may provide a notch between the “valley crook” and the stem having a width less than a diameter of the fishing line.

In an alternative embodiment of the present invention an in-line fishing coupler includes a shaft extending between a first end and a second end. The first end has an attachment “valley crook” having a stem extending from the shaft into a U-shaped bend defining a gap, and a tail extending from the U-shaped bend extending generally parallel to the shaft. The second end has a hook attachment.

The hook attachment may be a stem extending from the shaft into a U-shaped bend defining a gap, and a tail extending from the U-shaped bend extending generally parallel to the shaft.

These particular objects and advantages may apply to only some embodiments falling within the claims and thus do not define the scope of the invention.

### BRIEF DESCRIPTION OF THE DRAWINGS

FIG. 1 shows a first embodiment of the present invention showing a line attachment “valley crook” at the end of a fish hook opposite the bite;

FIG. 2 shows a second embodiment of the present invention showing a line attachment “valley crook” at a first end of a coupling device opposite a second end having an attachment for a fish hook; and

FIGS. 3A-3H shows the step-by-step method of attaching a fishing line to the fish hook of FIG. 1 having the line attachment “valley crook.”

### DETAILED DESCRIPTION OF THE PREFERRED EMBODIMENTS

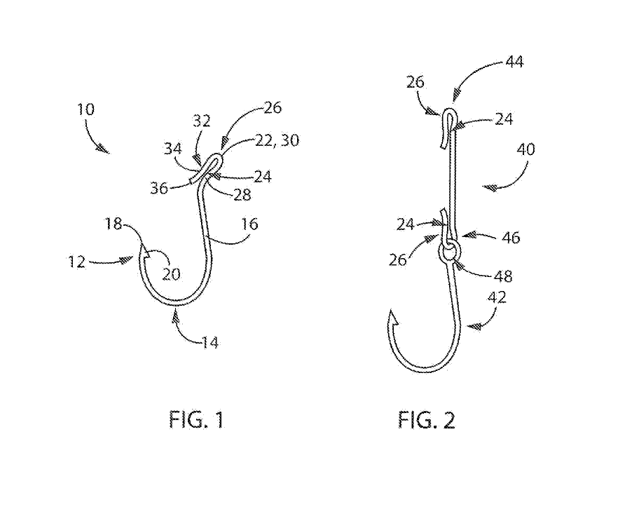

Referring now to FIG. 1, a first embodiment of the present invention is shown in connection with a fish hook 10. The fish hook has three sections: a bite end 12, a bend 14, and a shank 16. The bite end 12, bend 14, and shank 16 of the fish hook 10 is as substantially known in the art and described in U.S. Pat. No. 666,309; U.S. Pat. No. 2,668,387; U.S. Pat. No. 2,962,834; U.S. Pat. No. 5,386,660; and U.S. Pat. No. 8,201,358, each of which is hereby incorporated by reference.

The bite end 12 has a point 18 which is sharp and is configured to penetrate the fish's flesh or mouth and secures the fish to the hook 10. The bite end 12 may also include a barb 20 at the inner end of the point 18 and which is generally a reverse point that is designed to keep the fish on the hook 10. The bend 14 is the curved section of the hook which determines the gap or the width of the hook (from point to shank). The shank 16 connects the bend 14 to the end 22 of the hook 10 and is generally straight.

The end 22 of the hook, in accordance with the present invention, provides a “valley crook” attachment 26 having a narrow valley 24 for insertion of a fish line and knot. The “valley crook” attachment 26 may be angled away from the bite end of the hook 10 to facilitate attachment of the line. The “valley crook” attachment 26 may be angled between 0 and 90 degrees from the angle of the shank 16. Preferably, the “valley crook” attachment 26 is angled generally 45 degrees from the angle of the shank. The “valley crook” attachment 26 includes a generally straight stem 28 extending from the shank 16, although the stem 28 may be angled away from the shank 16.

The “valley crook” attachment 26 then includes a bend 30 which is a curved section that determines a width of the valley 24. The width of the valley 24 is slightly greater than the diameter of the fish line but less than the diameter of a knot placed in the fish line. It is contemplated that the width of the valley 24 may be slightly smaller than the diameter of the fish line but allows the fish line to fit within due to flexibility of the material.

The tail 32 of the “valley crook” attachment 26 connects the bend 30 to the tip 36 of hook 10. The tail 32 is generally shorter than the stem 28 and includes an inward dip 34 toward the stern 28 before the tip of the tail 32 extends generally parallel to the stem 28 or angled slightly outward from the stem 28. The inward dip 34 provides a notch between the tail 32 and the stem 28 which is slightly smaller than the diameter of the fish line. The inward dip 34 helps to secure the fish line within the valley 24 by “snapping” it within the valley 24. The flexibility of the material allows the line to be received within the valley past the inward dip 34. The tip 36 may be angled between 0 and 90 degrees form the angle of the tail 32. Preferably, the tip 36 is angled generally 45 degrees from the angle of the tail 32.

The total length of the fish hook 10, from the bend 14 to the end 22 of the “valley crook” attachment 26 typically measures between 0.5 inches to 3 inches or more. The width of the fish hook 10, from the point 18 to shaft 13, will generally range from to 0.25 inches to 1 inch. The material of the fish hook 10 may generally vary depending upon the intended purpose of the fish hook, the fish hook 10 may be made of metal, steel, stainless steel, high carbon steel, bronze, nickel, and other fish hook material known in the art. Fish hooks 10 come in a wide range of sizes and styles depending on the type of fishing and site and species of the catch.

Referring now to FIG. 2, a second embodiment of the present invention is shown in connection with an inline coupling device 40 for attaching a fish hook 42 to a line. A first end 44 of the coupling device 40 includes the “valley crook” attachment 26 as described above with respect to FIG. 1. A second end 46 of the coupling device may include a similar but enlarged version of the “valley crook” attachment 26. The second end 46 would have a greater valley 24 width to facilitate attachment of an eye 48 of a conventional fish hook 42.

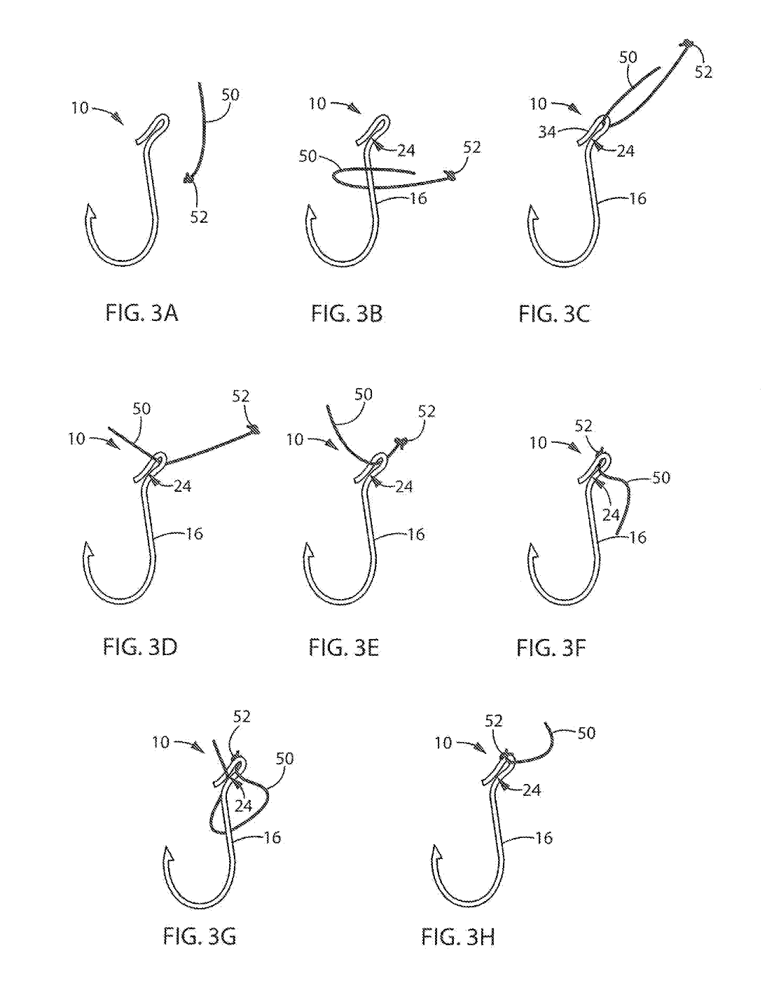

Referring now to FIGS. 3A-3H, a method of using the fish hook 10 of the present invention is shown. While the method is shown being applied to the “valley crook” attachment end 26 of FIG. 1, the same method can be used attach a line to the “valley crook” attachment end 26 of the first end 44 of the coupling device 40 of FIG. 2.

The method of attaching a fish line 50 to the fish hook 10 of FIG. 1 is as follows:

1) Select the desired hook size needed for the diameter and pound test of fishing line you are going to fish with.

2) Referring to FIG. 3A, take your fishing line 50 and tie a knot 52 approximately an inch from the end of the line 50.

3) Cut off the remaining line leaving a small tail of fish line 50 left

4) Referring to FIG. 3B, make an approximately one inch loop with the knot 52 on the down side, and hold it in one hand.

5) With the other hand, take the fish hook 10 and put the shaft 16 of the hook 10 thru the loop about halfway up the shank 16.

6) Referring to FIG. 3C-3D, pull the loop so it slides up the shank 16 and into the valley 24 until it stops all the way inside the valley 24. (As it starts to go thru the opening of the valley 24, you should feel a slight resistance as it clears the inward dip 34. This reassures that you have the right size valley 24 for the line 50 you are using.)

7) Referring to FIG. 3E, pull the line 50 up away from the hook 10 until the knot 52 seats within the valley 24.

8) Referring to FIG. 3F-3H, loop the line 50 one time around the opening of the valley 24, then pulling it thru the valley 24, and then pulling it tight. The line 50 may be looped additional times for additional security, repeating the step shown in FIG. 3F-3H. The fish hook 10 is now ready for bait.

9) In order to uninstall the fish hook 10 from the line 50, the looping is reversed or simply cut from the fish hook 10.

Certain terminology is used herein for purposes of reference only, and thus is not intended to be limiting. For example, terms such as “upper”, “lower”. “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component wider discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terns “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

I claim:

1. A fish hook comprising:
a hook defined by a point on a first end extending to a bend and a shank connecting the bend to a second end; and
an attachment crook at the second end having a stem extending from the shaft into a U-shaped bend defining a gap, and a tail extending from the U-shaped bend running generally parallel to the shaft
wherein the gap between the stem and the tail has a width less than a diameter of a knot of a fishing line.

2. The fish hook of claim 1 wherein the attachment crook is angled away from the first end.

3. The fish hook of claim 1 wherein a bend of the tail provides a gap between the crook and the stern having a width less than a diameter of the fish line.

4. An in-line fishing coupler comprising:
a shaft extending between a first end and a second end, the first end having an attachment crook having a stem extending from the shaft into a U-shaped bend defining a gap, and a tail extending from the U-shaped bend running generally parallel to the shaft, and the second end having a hook attachment.

5. The in-line fishing coupler of claim 4 wherein the hook attachment is a stein extending from the shaft into a U-shaped bend defining a gap, and a tail extending from the U-shaped bend running generally parallel to the shaft.
